(19) United States
(12) Patent Application Publication
(10) Pub. No.: US 2025/0138510 A1
(43) Pub. Date: May 1, 2025

(54) METHOD OF MANAGING A COLLABORATIVE WORK CELL

(71) Applicant: IDEA PROTOTIPI S.R.L., BASILIANO (UD) (IT)

(72) Inventor: Massimo AGOSTINI, COSEANO (UD) (IT)

(73) Assignee: IDEA PROTOTIPI S.R.L., BASILIANO (UD) (IT)

(21) Appl. No.: 18/837,076

(22) PCT Filed: Feb. 8, 2023
(86) PCT No.: PCT/IT2023/050037

§ 371 Date: Aug. 8, 2024

(30) Foreign Application Priority Data
Feb. 8, 2022 (IT) 102022000002300

(51) Int. Cl. G05B 19/418

(52) U.S. Cl. CPC G05B 19/41815; G05B 2219/31076

(57) ABSTRACT

Method carried out by a control unit of a collaborative work cell of managing the collaborative work cell comprising at least one work plane, a tool store, a user interface connected to the control unit, and an automatic operating device connected to the control unit, wherein the method comprises the following steps: receiving a first input comprising an indication on a type of operation to execute, wherein the first input is entered by an operator on the user interface; controlling the automatic operating device to execute an operation on the basis of the indication on the type of operation to execute comprised in the first input.

### FIELD OF THE INVENTION

The present invention concerns a method of managing a collaborative work cell provided with an automatic operating device to allow an operator to operate said automatic operating device.

### BACKGROUND OF THE INVENTION

To perform works on objects, the use of work cells is known which comprise a structure (work plane) for positioning the objects to be worked, for example objects to be welded, assembled, sanded, cleaned or other, and an automatic operating device for carrying out such works.

In general, the automatic operating device corresponds to a robot, possibly a robotic arm, commanded remotely and which is configured to be able to carry out all the movements of a human arm thanks to its six degrees of freedom.

The automatic operating device usually comprises a tool that is used to perform the working operations on the object positioned on the work plane.

A problem in performing an operation, like a work on an object, a calibration, or a setting of the automatic operating device using the aforementioned collaborative work cell often requires a substantial commitment by the operator in programming the automatic operating device and in providing the automatic operating device with commands to complete the operation. This can lead to slowdown in performing the operation, especially when the operation requires one or more tool changeovers or when an object has to undergo a plurality of operations.

Intense programming activity of the automatic operating device is also necessary when the operator has to calibrate, for example the movements, or set the automatic operating device.

There is therefore the need to provide a device and a method to facilitate the execution of an operation, whether it is working an object or a calibration, setup, setting, of an automatic operating device.

In addition, there is the need to provide a device and a method to facilitate the tasks of an operator who maneuvres such an automatic operating device.

In particular, one purpose of the present invention is to provide a device and a method of automating the execution of an operation (work or calibration and the like) by an automatic operating device.

Another purpose of the present invention is to provide a device and a method that can guarantee a high flexibility of use of the automatic operating device.

Another purpose of the present invention is to provide a device and a method that can be easily used by an operator acting on the automatic operating device.

A further purpose of the present invention is to provide an automatic operating device and a method to facilitate the movement/maneuvering of the aforesaid operating device.

A further purpose of the present invention is to provide a device and a method of commanding an automatic operating device through commands transmitted to the automatic operating device through a user interface.

A further purpose of the present invention is to provide a device and a method to facilitate the execution of setting and calibration operations through an interaction with the operator.

Another purpose of the present invention is to provide a device and a method to increase safety during the working steps.

The Applicant has devised, tested and embodied the present invention to overcome the shortcomings of the state of the art and to obtain these and other purposes and advantages.

There is therefore the need to perfect a method of managing a collaborative work cell that can overcome at least one of the drawbacks of the prior art.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, a method carried out by a control unit of a collaborative work cell for managing the collaborative collaboration cell is realized according to the present invention. The collaborative work cell comprises at least one work plane, a tool store, a user interface connected to the control unit and an automatic operating device connected to the control unit. The method of a control unit of a collaborative work cell realized by the following invention comprises the following steps: receiving a first input comprises an indication on a type of operation to execute; controlling the automatic operating device to execute an operation, on the basis of the indication on the type of operation to execute contained in the first input.

In doing so, at least the following advantages are obtained, namely to realize a method to increase the flexibility of use of an automatic operating device, for example a robot, a robotic arm, and the like; or to provide a method to facilitate working an object by an automatic operating device; or to provide a method that allows to command an automatic operating device through commands entered by an operator on a user interface; or to provide a method that allows to execute setting and calibration operations through an interaction between the operator and a user interface; or to provide a method that allows to increase safety during the working steps.

In accordance with one aspect of the present invention, the step of controlling the automatic operating device to execute the operation comprises controlling the automatic operating device to: approach the tool store of the collaborative work cell; select a tool comprised in the tool store on the basis of the indication comprised in the first input; install the tool on the automatic operating device; execute the operation using the selected tool.

In accordance with another aspect of the present invention the method comprises, when the step of executing the operation is completed, the step of controlling the automatic operating device to: approach the tool store of the collaborative work cell; uninstall the tool, return the tool in the tool store, and terminate the execution of the operation.

In accordance with another aspect of the present invention the method comprises, during the step of executing the operation, the step of controlling the automatic operating device to select the type of operation to be executed on the basis of the indication on the type of operation to be executed comprised in the first input and of working information contained in a memory of the control unit.

In accordance with another aspect of the present invention, the method comprises, during the step of executing the operation, the step of controlling the automatic operating device to: approach the tool store of the collaborative work cell; uninstall the tool and return the tool in the tool store; select a second tool from the tool store and install the second tool; continue the execution of the operation using the second tool.

In accordance with another aspect of the present invention the step of controlling the automatic operating device to execute the operation comprises receiving a second input; controlling the automatic operating device on the basis of the second input.

In accordance with another aspect of the present invention the second input is entered by an operator on the user interface connected to the control unit.

In accordance with another aspect of the present invention the step of controlling the automatic operating device on the basis of the second input comprises controlling the automatic operating device to terminate the execution of the operation.

In accordance with another aspect of the present invention, the operation being executed and the second operation are one of either an operation of working an object positioned on the work plane or an operation of calibration of the automatic operating device.

A further purpose of the present invention is to provide a control unit comprising a memory unit of a collaborative work cell comprising at least one work plane, a tool store, a user interface connected to the control unit, and an automatic operating device connected to the control unit, wherein the control unit is configured to carry out a method of managing the collaborative collaboration cell.

In another aspect of the present invention, the purpose is to provide a collaborative work cell comprising at least one work plane, a tool store, a control unit comprising a memory unit, an automatic operating device connected to the control unit, and a user interface connected to the control unit, wherein the control unit is configured to carry out a method of managing the collaborative collaboration cell.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a perspective view of a collaborative work cell;

FIG. 2 is a diagram of a control unit of a collaborative work cell;

FIG. 3 is a flowchart of a method according to an example of the present invention;

FIG. 4 is a flowchart of a method according to an example of the present invention;

FIG. 5 is a flowchart of a method according to an example of the present invention;

FIG. 6 is a flowchart of a method according to an example of the present invention.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

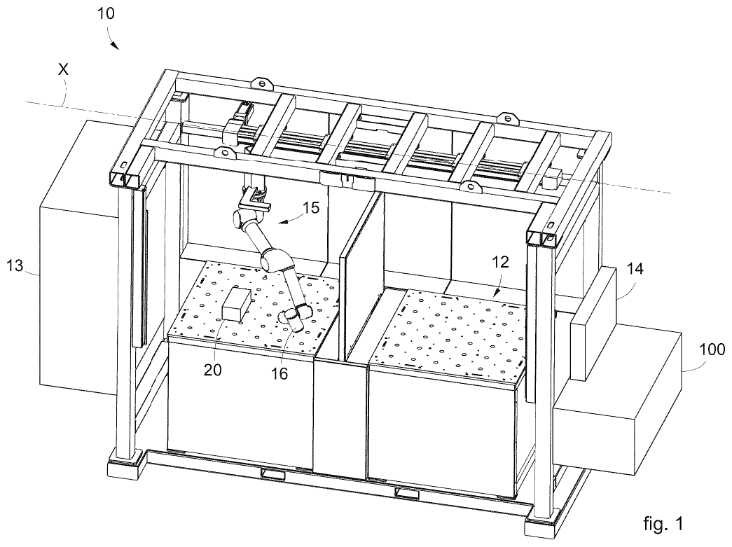

With reference to FIG. 1, a collaborative work cell 10 comprises a control unit 100, at least one work plane 12, a tool store 13, a user interface 14 connected to the control unit 100 and an automatic operating device 15 connected to the control unit 100.

Said at least one work plane 12 consists of a substantially flat surface configured to support the object 20 on which to perform a working operation.

The tool store 13 consists of any space or place defined in the collaborative work cell 10 or any case, receptacle, container, and the like, comprised in the collaborative work cell 10 that are configured and suitable for the deposit, storage, arrangement, and retrieval, by an automatic operating device 15 or by an operator, of at least one tool 16. The person skilled in the art will understand that the tool store 13 can also be external to the collaborative working cell 10 without this affecting the purpose of protection of the invention.

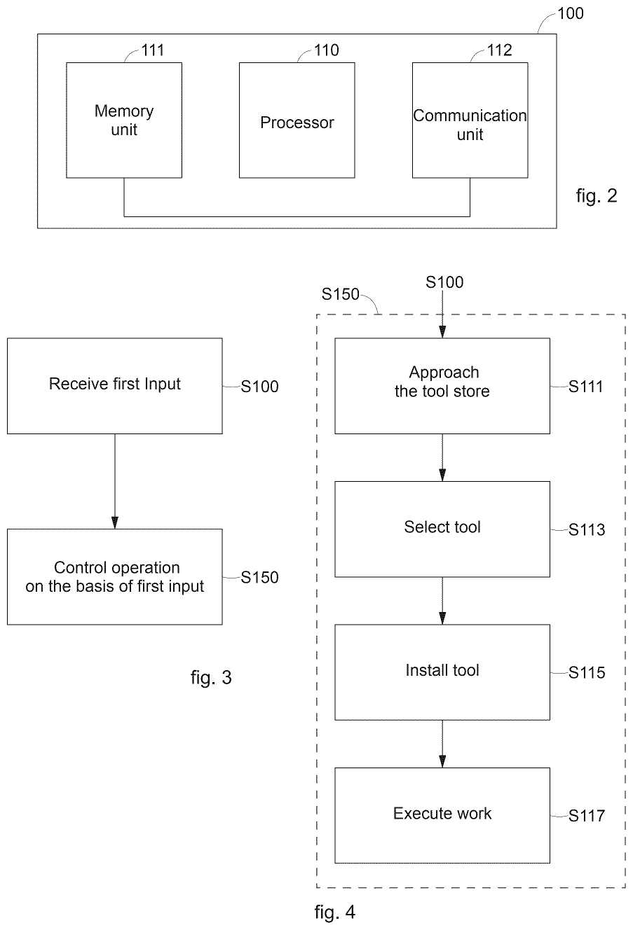

With reference to FIG. 2, the control unit 100 is an electronic element that allows to carry out calculations and the reception (transmission) of electronic signals, such as operational commands, data, etc., both from (to) various elements of the control unit 100 itself and from (to) external electronic devices, such as the user interface 14 or other electronic devices external to the collaborative work cell 10. Further, the control unit 100 allows data to be stored in a memory unit.

Generally, the control unit 100 comprises at least one processor 110 for executing calculation operations and/or for generating operational commands, a memory unit 111 connected to the processor 110, and a communication unit 112 connected to the processor 110 and to the memory unit 111.

The memory unit 111 may consist of any physical medium configured for storing data such as a hard disk, a solid-state memory unit, an optical disk, a magneto-optical disk, and the like. The person skilled in the art will understand that the presence of a memory unit 111 within the control unit 100 is not a fundamental feature of the invention, as the purpose of protection of the invention does not vary if the memory unit is external and physically or wirelessly connected with the control unit 100.

The communication unit 112 is configured to ensure the communication, reception and/or transmission, of electrical signals between the processor 110 and the memory unit 111 and between the processor 110 and elements of the collaborative work cell 10 such as the automatic operating device 15 and the user interface 14. The communication unit 112 is configured to perform communication of electrical signals both through physical medium (not shown in the figure), an electrical cable, a wire, a conductive path, a conductive trace, etc., and wirelessly.

The processor 110 is the element of the control unit 100 that allows the control of the memory unit 111, of the user interface 114, of the communication unit 112. The processor 110 may control the memory unit 111 and the user interface 114 directly or via the communication unit 112. Further, through the communication unit 112, the processor 110 controls the operations of devices external to the control unit 100, such as the automatic operating device 15, the tool store 13 and other external electronic devices connected both through physical medium, such as a cable, a wire, a conductive trace, a conductive path and the like, and wirelessly.

Hereinafter, the operations performed by the processor 110 will be described as operations of the control unit 100. The person skilled in the art will have no problem in understanding which elements of the control unit 100 are involved in carrying out the operations. The person skilled in the art will also understand that the description of the invention will refer interchangeably to operations of the control unit 100 and of the processor 110 without thereby affecting the purpose of protection of the invention.

In one example of the invention, with reference to FIG. 3, the control unit 100 or the processor 110 is configured to receive, in the reception step S100, the first input from the user interface 114. An operator selects on the user interface 14 an operation that the automatic operating device 15 must execute. The operation that the automatic operating device 15 must execute comprises at least one movement of the automatic operating device 15. Alternatively, the operation comprises at least one movement of the automatic operating device 15 and the implementation of a tool 16, wherein the implementation of a tool 16 comprises the installation thereof on the automatic device 15.

The operation that the automatic operating device 15 must execute comprises at least one of either an operation of working an object and a calibration, setup, setting of the automatic operating device 15 itself or of the tool 16 connected to the automatic operating device 15.

In the case where the operation that the automatic operating device must execute is working an object, an operator provides an object 20, positioning the object 20 to be worked on the work plane 12 of the collaborative work cell 10.

The operator, by acting on the user interface 14, selects a type of work to be executed on the object 20. To allow the selection of the type of work to be executed, the user interface 14 may display at least one graphic mark such as a drawing, a text, an icon, a widget, and the like or may emit acoustic and/or tactile signals or a combination of graphic marks and acoustic and/or tactile signals.

The user interface 14 is provided with at least one input means (not shown in the figures) to allow the operator to enter a first input to select the type of work to be executed. The input means may consist of at least one of either a physical button, a touch pad, a touchscreen, an electronic pointing device, and any device, mechanical or electronic, that allows an input to be entered into the user interface 14.

When the operator has entered the first input into the user interface 14, the first input is transmitted to the control unit 100. The first input may be transmitted directly from the user interface 14 or through the communication unit 112 to the processor 110. The first input comprises an indication of a type of operation to execute, in other words, an indication of a type of operation that the automatic operating device 15 must execute.

After receiving the first input, the control unit 100 is configured to control, in the control step S150, the automatic operating device 15 to execute an operation on the basis of the indication of the type of operation to execute comprised in the first input. The processor 110 controls the automatic operating device 15 by sending at least one signal to the automatic operating device 15, wherein the signal comprises at least one operational command that allows the automatic operating device 15 to execute the operation.

When the type of operation to be executed corresponds to working an object 20, the automatic operating device 15 executes the work of the object on the basis of the operational command or of the commands received from the processor 110. The operational commands to be sent to said device (15) may be preset in an internal memory of the processor 110 or may be stored in the memory unit 111.

With reference to FIG. 4, at the time when the operator selects the type of work to be executed, the automatic operating device 15 may be in a state of inactivity and/or have no tool connected to it to execute the work of the object 20. In this case, in the control step S150 the control unit 100 or the processor 110 are configured, through the transmission of operational commands to the automatic operating device 15, to control, in the approach step S111, the automatic operating device 15 to approach the tool store 13 of the collaborative work cell 10 and, in the selection step S113, to select a tool 16 comprised in the tool store 13 depending on the work to be executed on the object 20, in other words, on the basis of the indication of the type of operation to execute comprised in the first input.

Once the tool is selected from the tool store 13, the processor 110 or the control unit 100 are configured to control, in the installation step S115, the automatic operating device 15 to install the tool 16 on the automatic operating device 15 and, in the execution step S117, to execute the operation using the selected and installed tool 16.

The selection of the tool from the tool store 13 is executed using a predefined tool mapping. In one example of the present invention, the position of each tool in the tool store 13 is pre-recorded in the memory unit 111. In an alternative, the mapping of the position of the tools in the tool store 13 is entered manually by the operator. In another alternative, the mapping of the position of the tools in the tool store 13 is known to the processor.

The automatic operating device 15 is moved so as to reach the position of the tool in the tool store 13 on the basis of the indication on the type of operation to execute comprised in the first input.

The processor 110 or the control unit 100 are configured to control, in the execution step S117, the automatic operating device 15 to select the type of operation to execute on the basis of the indication on the type of operation to execute comprised in the first input and on the basis of working information contained in a memory unit comprised in the control unit.

With reference to FIG. 5, in an example of the present invention, in case the operation envisages changing the tool connected to the automatic operating device, the processor 110 or the control unit 100 are configured to control, after or during the execution step S117 of the operation, the automatic operating device 15 to approach, in the approach step S119, the tool store 13 of the collaborative work cell. Here the processor 110 or the control unit 100 are configured to control, in the uninstallation step S121, the automatic operating device 15 to uninstall the tool 16 and return it in the tool store 13 at the position associated with the tool 16.

In one example of the present invention, once the tool 16 is uninstalled and returned, the processor 110 or the control unit 100 are configured to control, in the step of selecting a second tool S131, the automatic operating device 15 to select a second tool from the tool store 13 and install it on the automatic operating device 15. The automatic operating device 15 continues the execution of the operation using the second tool.

Alternatively, once the tool 16 is uninstalled and returned, the processor 110 or the control unit 100 are configured to control, in the end step S160, the automatic operating device 15 to terminate the execution of the operation.

Regardless of the method steps, the processor 110 or the control unit 100 are configured to control, at any time, the automatic operating device 15 to terminate the execution of the operation on the basis of the first input.

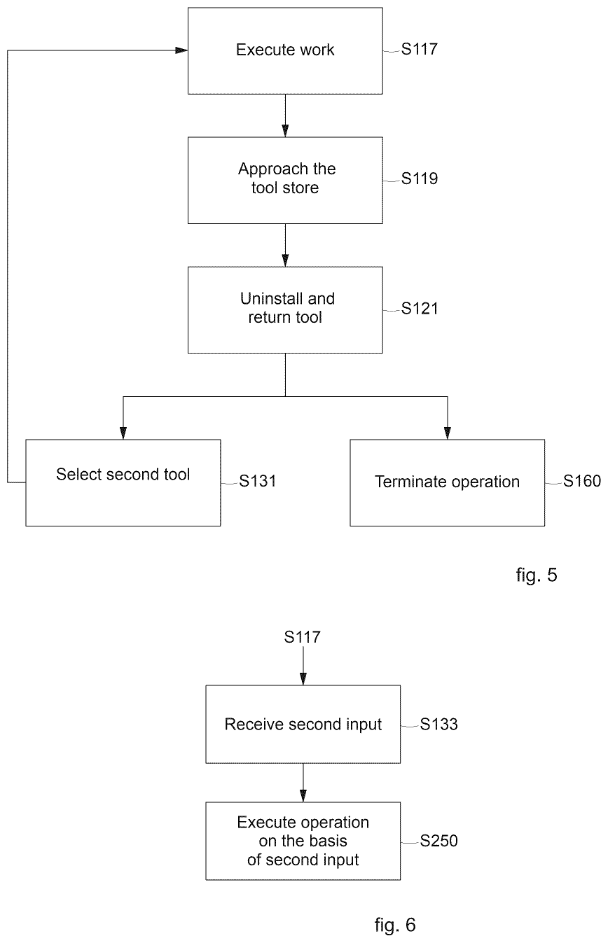

With reference to FIG. 6, in an example of the present invention, the processor 110 or the control unit 100 receives, in the reception step S133, a second input and are configured to control, in the execution step S250, the automatic device 15 to execute a second operation on the basis of the second input.

The second input may be generated automatically by the automatic operating device 15, for example in case of malfunction or anomaly of the automatic operating device 15 or on the basis of the measurement of parameters, such as temperature of the object to be worked, temperature of the environment in which the collaborative working cell 11 is located, limited power supply of the automatic device 15, potential difference drops associated with the electric current powering the collaborative working cell 10, etc.

Alternatively, the second input is an input entered, during the execution of the operation, by an operator on the user interface 14 connected to the control unit 100, exactly as described for the first input, to the description of which reference is made.

The second input may comprise an indication for the automatic operating device 15 to terminate the execution of the operation or may comprise an indication for the automatic operating device 15 to execute a further operation equal to or different from the operation being currently executed. The execution of the work can proceed as described with reference to FIGS. 3, 4, and 5 in relation to the first input, to which reference is made.

Both the operation being executed and the second operation are one of either an operation of working an object positioned on the work plane or an operation of calibration of the automatic operating device.

It will be clear to the person skilled in the art that, depending on the operation to execute, the present invention comprises every possible combination of the examples of the present invention which have been described above. In other words, the processor 110 or the control unit 100 are configured to control the automatic operating device 15 according to any combination of the examples described in FIGS. 3, 4, 5, and 6.

It is clear that modifications and/or additions of parts can be made to the method, the processing cell 10, and the control unit 100 as described heretofore, without thereby departing from the field and scope of the present invention, as defined by the claims.

It is also clear that, although the present invention has been described with reference to some specific examples, a person of skill in the art shall certainly be able to achieve other equivalent forms, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Method of managing a collaborative work cell (10) carried out by a control unit (100) thereof to which a user interface (14) and an automatic operator device (15) are connected, and comprising at least one work plane (12) and a tool store (13), characterized in that the method comprises the following steps:
receiving (S100) a first input comprising an indication on a type of operation to execute, wherein the first input is entered by an operator on the user interface (14);
controlling (S150) said automatic operator device (15) to execute an operation on the basis of the indication on the type of operation to execute comprised in the first input.

2. Method as in claim 1, characterized in that the step of controlling said automatic operating device (15) to execute the operation comprises:
approaching (S111) the tool store (13) of the collaborative work cell;
selecting (S113) a tool comprised in said tool store (13) on the basis of the indication comprised in the first input;
installing (S115) the tool on said device (15);
executing (S117) the operation using the selected tool.

3. Method as in claim 1, characterized in that said method comprises, during the step (S117) of executing the operation, the step of controlling said automatic operating device (15) so that it selects the type of operation to be executed on the basis of the indication on the type of operation to be executed comprised in the first input and on the basis of working information contained in a memory unit (111) comprised in the control unit (100).

4. Method as in claim 2, characterized in that, when the step (S117) of executing the operation is completed, the method comprises the steps of controlling said device (15) to:
approach (S119) said tool store (13) of said work cell (10);
uninstall (S121) the tool and return the tool in said store (13), and
terminate (S160) the execution of the operation.

5. Method as in claim 2, characterized in that the method comprises, during the step (S117) of executing the operation, the step of controlling said device (15) to:
approach (S119) said store (13) of said work cell (10);
uninstall (S121) the tool and return the tool in said store (13);
select (S131) a second tool from said store (13) and install the second tool;
continue (S117) the execution of the operation using the second tool.

6. Method as in claim 1, characterized in that the step of controlling said device (15) to execute the operation comprises:
receiving (S133) a second input;
controlling (S250) said device (15) on the basis of the second input.

7. Method as in claim 6, characterized in that the second input is entered by an operator on the user interface (14) connected to said control unit (100).

8. Method as in claim 7, characterized in that the step of controlling said device (15) on the basis of the second input comprises the control of said device (15) so that it terminates (S160) the execution of the operation.

9. Method as in claim 8, characterized in that the step of controlling said device (15) on the basis of the second input comprises controlling said device (15) to execute (S117) another operation that is different from the operation being executed.

10. Method as in claim 1, characterized in that the operation being executed and the second operation are one of either an operation of working an object positioned on at least one said work plane (12) or an operation of calibration of said device (15).

11. Control unit (100), to which there are connected a user interface (14) and an automatic operator device (15), comprising a memory unit (111), of a collaborative work cell (10) comprising at least one work plane (12), a tool store (13), characterized in that said control unit (100) is configured to carry out the method as in claim 1.

12. Collaborative work cell (10) comprising at least one work plane (12), a tool store (13), a control unit (100), comprising a memory unit (111), to which there are connected an automatic operator device (15) and a user interface (14) characterized in that said control unit (100) is configured to carry out the method as in claim 1.
